(19) United States
(12) Patent Application Publication
(10) Pub. No.: US 2002/0004716 A1
(43) Pub. Date: Jan. 10, 2002

(54) Transmitter for transmitting a signal encoded in a narrow band, and receiver for extending the band of the encoded signal at the receiving end, and corresponding transmission and receiving methods, and system

(76) Inventor: Gilles Miet, Le Mans (FR)

Correspondence Address: U.S. Philips Corporation, 580 White Plains Road, Tarrytown, NY, 10591, US

(21) Appl. No.: 09/861,938

(22) Filed: May 21, 2001

(30) Foreign Application Priority Data
May 26, 2000 (EP) 00401494.0

(51) Int. Cl. G10L 19/08; G10L 19/04

(52) U.S. Cl. 704/219

(57) ABSTRACT

The invention relates to a transmitter and a receiver for extending the spectral band of the signal at the receiving end, the transmitted signal being encoded in the narrow band. The invention comprises means for predicting a wide-band signal on the basis of the narrow-band signal, representing the original signal, means for estimating a prediction error by comparison of the prediction with the original signal, and means for transmitting the prediction error with the signal encoded in the narrow band so as to contribute to the reconstruction of a wide-band signal at the receiving end.

Application: digital telecommunication, mobile radiotelephony.

The invention relates to the transmission and reception of speech signals, particularly for telecommunication systems in which the spectrum width of the transmitted signal is limited.

The invention finds numerous applications, notably in mobile radiotelephony systems for improving the quality of the speech signal at the receiving end.

These systems generally involve an encoding of the source for reducing the quantity of information to be transmitted and thus increasing the capacity of the transmission channel. The source encoding, which is speech encoding in the case of telephonic transmissions, is often related to a reduction of the spectrum of the message to be transmitted. This reduction of the spectrum is generally accompanied by a diminution of the audio quality of the signal at the receiving end. To remedy this problem, various methods, referred to as spectrum extension, have been elaborated for extending the spectral band of the received signal at the receiving end.

One of these methods is described in U.S. Pat. No. 5,581,652. It relates to a method of reconstructing a wide-band speech signal from a speech signal received in a band having a narrower spectrum. The method comprises the use of a pair of interrelated speech dictionaries. A first dictionary is used for analyzing the received speech signal with the aid of a first series of vectorial codes having a narrower spectral band than the band of the original signal before transmission. A second dictionary allows extension of the spectral band of the received signal by assigning to it a second series of vectorial codes in a larger band and corresponding to the codes analyzed in the narrow band.

These methods allow a posteriori reconstruction of a wide-band signal by means of transmitted single information in the received narrow-band signal.

It is an object of the invention to improve the performance of these methods without significantly increasing the quantity of transmitted data. To this end, the invention provides a transmitter, a receiver, a system, a transmission method and a reception method in which the original signal is first encoded in the narrow band with a view to its transmission, a prediction of the wide-band signal is subsequently effected on the basis of the narrow-band signal representing the signal, a prediction error is then computed by comparing the obtained prediction signal with the original signal for transmitting the prediction error thus obtained with the wide-band signal, with a view to contributing to the reconstruction of a wide-band signal at the receiving end.

These and other aspects of the invention are apparent from and will be elucidated, by way of non-limitative example, with reference to the embodiments described hereinafter.

In the drawings:

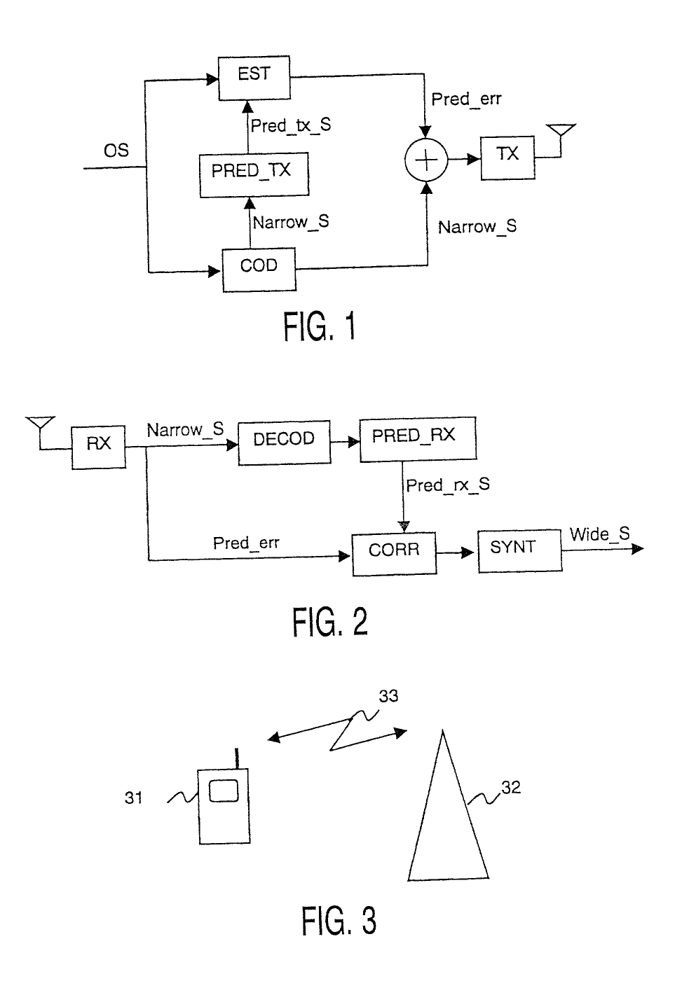

FIG. 1 is a principal circuit diagram showing a transmitter according to the invention.

FIG. 2 is a principal circuit diagram showing a receiver according to the invention.

FIG. 3 is a circuit diagram showing a system according to the invention.

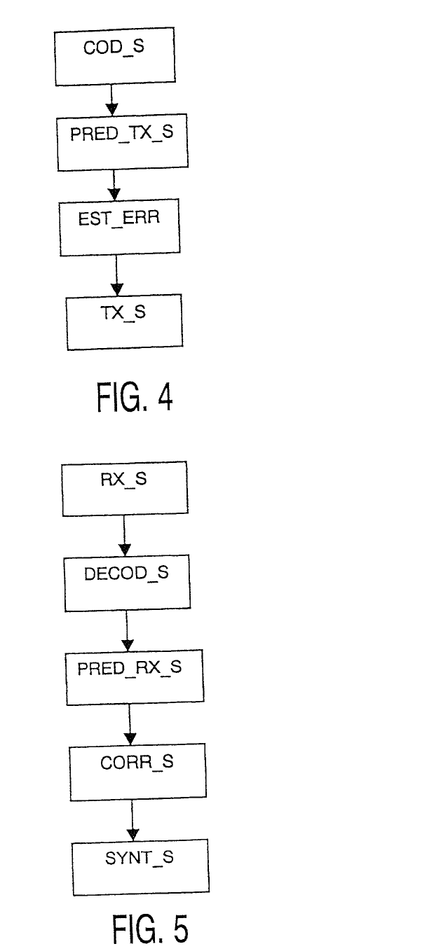

FIG. 4 is a flow chart illustrating a transmission method according to the invention.

FIG. 5 is a flow chart illustrating a reception method according to the invention.

Embodiments of a transmitter and a receiver according to the invention are shown in FIGS. 1 and 2, respectively. They are provided to transmit and receive, respectively, a speech signal, referred to as original signal, having a given spectral band, referred to as original band.

The transmitter shown in FIG. 1 comprises:

a speech encoding module COD for effecting an encoding in the narrow band of the original speech signal OS and for obtaining, with a view to its transmission, a speech signal Narrow_S encoded in a spectral band, referred to as narrow band, which is narrower than the original band,

prediction means PRED_TX for predicting a wide-band signal Pred_tx_S representing the original signal based on the narrow-band signal (possibly encoded and subsequently decoded),

error estimation means EST for estimating a prediction error Pred_err between the predicted wide-band signal Pred_tx_S and the original speech signal OS,

transmission means TX for transmitting said narrow band-encoded speech signal Narrow_S as well as the prediction error Pred_err.

The receiver shown in FIG. 2 comprises:

a reception block RX for receiving the narrow-band encoded speech signal Narrow_S as well as the transmitted prediction error Pred_err,

a speech decoding block DECOD for decoding the received narrow-band speech signal Narrow_S,

a prediction block PRED_RX for predicting, on the basis of the signal received in the narrow band Narrow_S, a signal Pred_rx_S having a spectral band which is larger than the narrow band,

a correction block CORR for correcting the predicted signal Pred_rx_S with the aid of the received prediction error Pred_err,

a speech synthesis block SYNT for synthesizing, on the basis of the corrected wide-band signal, a wide-band speech signal Wide S having a spectral band which is larger than the narrow band.

The predicted wide-band signal Pred_tx_S, the original signal OS, the signal received in the narrow band Narrow_S, the predicted signal Pred_rx_S or the corrected wide-band signal are also understood to be speech parameters which are characteristic of the signal concerned and which allow their synthesis. These parameters may be, for example, linear prediction parameters of the LPC type (Linear Predictive Coding) or spectral envelope parameters of the LSF type (Line Spectral Frequencies) or any other parameters allowing reconstitution of a signal.

The transmission block TX and the reception block RX comprise means for respective encoding and decoding of the channel, as provided by the telecommunication standard in force, for protecting the data during transmission. The speech encoder COD is preceded by filtering and sampling means of the conventional type (not shown) such as are recommended by the ITU-T standard and particularly parts G.711 and G.712 for transforming the original signal into a digital signal OS. The prediction means PRED_TX and PRED_RX at the transmitting and receiving ends preferably comprise blocks of similar programs. They may comprise means for predicting spectral envelope parameters of the LSF type using, for example, a technique currently referred to as “code book mapping”. This technique allows extrapolation, on the basis of envelope parameters of a signal having a narrow spectral band, of envelope parameters in a larger spectral band representing the same signal, using a pair of speech dictionaries.

The prediction error Pred_err and the signal encoded in the narrow band Narrow_S are preferably transmitted in the same speech frame. The data are subsequently divided in the frame in accordance with a predetermined division as a function of the robustness to transmission errors searched for the whole system, which also depends on the encoding of the channel used. At the receiving end, the data are restored and separated in accordance with the division chosen at the transmitting end.

In accordance with a preferred embodiment of the invention, the prediction means PRED_TX comprise:

a linear predictive analysis block LP_TX for analyzing and extracting the LSF envelope parameters of the original speech signal as well as the LSF parameters of the speech signal encoded in the narrow band,

a programmed prediction block MAP_TX for predicting, on the basis of the LSF parameters of the narrow-band encoded signal, the LSF wide-band parameters of the wide-band signal. The prediction program may be defined, for example, for performing a known method of the code book mapping type.

In accordance with this embodiment, the error estimation means EST may comprise a comparator COMP for comparing the predicted LSF wide-band parameters based on the narrow-band encoded signal with those of the original signal so as to derive a prediction error which will be subsequently quantized before its transmission.

At the receiving end, the prediction means PRED_RX may also comprise:

a predictive analysis block LP_RX for analyzing the narrow-band signal received after decoding so as to extract the LSF parameters from the decoded signal,

a prediction block MAP_RX for predicting the LSF parameters of a wide-band signal on the basis of the LSF parameters of the signal received in the narrow band.

The correction means CORR may be programmed for correcting the predicted LSF wide-band parameters by means of the received quantized prediction error.

At the receiving and transmitting ends, all the algorithms of the invention may be realized by means of a digital signal processor DSP.

FIG. 3 shows an embodiment of the system according to the invention principally constituted by a radiotelephone 31, a radio base station 32 and an air transmission channel 33, the assembly illustrating a descending radio transmission between the radio base station 32 and the radiotelephone 31. The radio base station 32 comprises a transmitter of the type shown in FIG. 1 and the radiotelephone 31 comprises a receiver of the type shown in FIG. 2. In the case of an ascending transmission between the radiotelephone and the radio base station, the radiotelephone 31 may comprise a transmitter as shown in FIG. 1 and the radio base station may comprise a receiver as shown in FIG. 2. The receiver may also be present in another radiotelephone (not shown) which is used as a destination for the message sent by the radiotelephone 31. Such a system allows extension, at the receiving end, of the spectral band of an encoded speech signal transmitted in a narrower band than the band of the original signal. This extension of the spectrum, effected before restitution of the speech signal to a user, improves the quality of the received signal. Such a system is particularly advantageous in the field of mobile radiotelephony where the available frequency spectrum is limited. The invention is also advantageous in all multiple access telecommunication systems in which the passband is shared by all users of the system.

An advantage of the system of FIG. 3 is that it allows improvement of the quality of the received signal without substantially increasing the quantity of data transmitted through the transmission channel. By way of practical example, for a system of the GSM type (Global System for Mobile communications) functioning in accordance with a full-rate encoding of about 13 kbit/s, the invention may provide, for example, the rate at about 13.1 kbit/s or slightly more (about 14-16 kbit/s), which is negligible for the majority of current applications. This very small increase of the rate is due to the fact that the transmission means TX situated in the transmitter transmit, in addition to the useful narrow-band signal encoded in accordance with a conventional speech encoding method, a prediction error Pred_err estimated by the transmitter.

FIG. 4 shows a simplified flow chart of an embodiment of the transmission method according to the invention, which can be carried out by a transmitter as shown in FIG. 1, in accordance with an appropriate program stored in a memory of the transmitter. The transmission method comprises:

a speech encoding step COD_S for effecting an encoding in the narrow band of the original speech signal and for obtaining, with a view to its transmission, a speech signal encoded in a spectral band, referred to as narrow band, which is narrower than the original band,

a prediction step PRED_TX_S for predicting a wide-band signal representing the original signal in the narrow band (possibly encoded and subsequently decoded),

an error estimation step EST_ERR for estimating a prediction error between the predicted wide-band signal and the original speech signal,

a transmission step TX_S for transmitting said speech signal encoded in the narrow band, as well as the prediction error.

In accordance with a preferred embodiment of the invention, in which the different signals are represented by their characteristic speech parameters, the prediction step PRED_TX_S comprises the following sub-steps:

a first sub-step of linear predictive analysis for analyzing and extracting the LSF envelope parameters from the original speech signal,

a second sub-step of linear predictive-analysis for analyzing and extracting the LSF envelope parameters LSF from the speech signal encoded in the narrow band,

a sub-step of predicting the LSF wide-band parameters of the wide-band signal on the basis of the LSF parameters of the narrow-band signal, for example, by means of a known method of the code book mapping type.

The error estimation step EST_ERR may consist of a step of comparing the predicted LSF wide-band parameters with those of the original signal so as to derive the prediction error which is subsequently quantized before its transmission.

FIG. 5 shows a simplified flow chart of an embodiment of the receiving method according to the invention, adapted to the transmission method of FIG. 3, which method can be carried out by a receiver as shown in FIG. 2. The method of extending the band at the receiving end comprises:

a receiving step RX_S for receiving the speech signal encoded in the narrow band, as well as the transmitted prediction error,

a speech decoding step DECOD_S for decoding the received narrow-band speech signal,

a prediction step PRED_RX_S for predicting, on the basis of the signal received in the narrow band, a signal, referred to as wide-band signal, having a spectral band which is larger than the narrow band,

a correction step CORR_S for correcting the wide-band signal predicted by means of the received prediction error,

a speech synthesis step SYNT_S for synthesizing, on the basis of the corrected wide-band signal, a speech signal having a spectral band which is larger than the narrow band.

In accordance with a preferred embodiment of the invention, in which the different signals are identified by their respective speech parameters, the prediction step PRED_RX_S carried out in the receiving method comprises the following sub-steps:

a sub-step of predictive analysis of the narrow-band signal received after decoding for extracting the LSF parameters from the decoded signal,

a prediction sub-step for predicting the LSF wide-band parameters of the received signal on the basis of the LSF parameters extracted in the narrow band.

The correction step CORR_S may consist of a step of correcting the LSF wide-band parameters by means of the received quantized prediction error.

1. A transmitter for transmitting an original speech signal having a given spectral band, referred to as original band, the transmitter comprising:
a speech encoding block for effecting an encoding in the narrow band of the original speech signal and for obtaining, with a view to its transmission, a speech signal encoded in a spectral band, referred to as narrow band, which is narrower than the original band,
a prediction block for predicting, on the basis of the narrow-band signal, a signal referred to as wide-band signal, having a spectral band which is larger than the narrow band and representing the original signal,
an error estimation block for estimating a prediction error between the predicted wide-band signal and the original speech signal,
a transmission block for transmitting said speech signal encoded in the narrow band, as well as the prediction error.

2. A receiver for receiving a speech signal, the receiver comprising:
a reception block for receiving a speech signal encoded in the narrow band, as well as a prediction error,
a speech decoding block for decoding the received narrow-band speech signal,
a prediction block for predicting, on the basis of the signal received in the narrow band, a signal, referred to as wide-band signal, having a spectral band which is larger than the narrow band,
a correction block for correcting the predicted wide-band signal by means of the received prediction error,
a speech synthesis block for synthesizing, on the basis of the corrected wide-band signal, a speech signal having a spectral band which is larger than the narrow band.

3. A method of transmitting an original speech signal having a given spectral band, referred to as original band, the method comprising:
a step of speech encoding for effecting an encoding in the narrow band of the original speech signal and for obtaining, with a view to its transmission, a speech signal encoded in a spectral band, referred to as narrow band, which is narrower than the original band,
a prediction step for predicting a wide-band signal representing the original signal,
an error estimation step for estimating a prediction error between the predicted wide-band signal and the original speech signal,
a transmission step for transmitting said speech signal encoded in the narrow band, as well as the prediction error.

4. A computer program product for a transmitter as claimed in claim 1, the product comprising software code portions which, once loaded into the transmitter, enable it to perform the steps of the method as claimed in claim 3.

5. A method of extending the band at the receiving end, adapted to a speech signal transmitted by means of a transmission method as claimed in claim 3, the method comprising:
a receiving step for receiving a speech signal encoded in the narrow band, as well as a prediction error,
a speech decoding step for decoding the received narrow-band speech signal,
a prediction step for predicting, on the basis of the signal received in the narrow band, a signal, referred to as wide-band signal, having a spectral band which is larger than the narrow band,
a correction step for correcting the wide-band signal predicted by means of the received prediction error,
a speech synthesis step for synthesizing, on the basis of the corrected wide-band signal, a speech signal having a spectral band which is larger than the narrow band.

6. A computer program product for a receiver as claimed in claim 2, the product comprising software code portions which, once loaded into the receiver, enable it to perform the steps of the method as claimed in claim 5.

7. A telephone for transmitting encoded speech signals intended for a digital telecommunication system, characterized in that it comprises a transmitter as claimed in claim 1.

8. A telephone for receiving encoded speech signals from a digital telecommunication system, characterized in that it comprises a receiver as claimed in claim 2.

9. A digital telecommunication system for transmitting and receiving speech signals, characterized in that it comprises at least a transmitter as claimed in claim 1 and at least a receiver as claimed in claim 2.

10. A speech signal having a given spectral band, referred to as original band, the transmitter comprising [A claim 1].
